(19) United States
(12) Patent Application Publication
(10) Pub. No.: US 2026/0162279 A1
(43) Pub. Date: Jun. 11, 2026

(54) TRACKING DEVICE, TRACKING METHOD, AND STORAGE MEDIUM

(71) Applicant: NEC Corporation, Tokyo (JP)

(72) Inventors: Yasunori BABAZAKI, Tokyo (JP); Toru TAKAHASHI, Tokyo (JP); Takashi SHIBATA, Tokyo (JP)

(73) Assignee: NEC Corporation, Tokyo (JP)

(21) Appl. No.: 19/358,628

(22) Filed: Oct. 15, 2025

(30) Foreign Application Priority Data
Nov. 7, 2024 (JP) 2024-195006

(51) Int. Cl. G06T 7/246; G06V 10/20

(52) U.S. Cl. CPC G06T 7/248; G06V 10/255; G06T 2207/10016; G06T 2207/30241

(57) ABSTRACT

The tracking device 1X includes a first inference means 24X, a second inference means 25X, and an identification means 26X. The first inference means 24X is configured to perform, upon obtaining a target image including a plurality of objects at a reference time, first inference for inferring a motion of a tracking target at the reference time on assumptions that the objects are respectively regarded as the tracking target tracked based on time-series images obtained before the reference time. The second inference means 25X is configured to perform second inference for inferring a motion of the tracking target at the reference time based on the time-series images. The identification means 26X is configured to identify an object representing the tracking target among the plurality of objects in the target image, based on inference results of the first inference for the assumptions and an inference result of the second inference.

### INCORPORATION BY REFERENCE

This application is based upon and claims the benefit of priority from Japanese Patent Application No. 2024-195006, filed on Nov. 7, 2024, the disclosure of which is incorporated herein in its entirety by reference.

### TECHNICAL FIELD

The present disclosure relates to a technical field of a tracking device and a tracking method for tracking an object using time-series images, and a storage medium.

### BACKGROUND

There is a technology for tracking an object such as a person or a thing from time-series images. For example, JP 2023-170234 A discloses a tracking system that extracts a person's position in an image by using machine learning, associates detected persons by using a predicted positions of the persons obtained by past tracking (chasing) processing, and allocates a tracking ID to each person. JP 2023-170234 A also discloses processing related to detection and prediction of an action of a person to be tracked.

### CITATION LIST

### Patent Literature

Patent Literature 1: JP 2023-170234A

### SUMMARY

In a state where persons approach each other, there is a case where the tracking fails due to allocation of the tracking ID to a wrong person. Since appearance information is not useful for tracking at an industrial site such as a site where work uniforms are the same, such erroneous allocation of the tracking ID is likely to occur. Therefore, it is desirable to accurately track a target without depending on appearance information.

In view of the above-described problem, an object of the present disclosure is to provide a tracking device and a tracking method capable of accurately identifying a tracking target from an image, and a storage medium.

In an example aspect of the present disclosure, there is provided a tracking device including:
a first inference means for performing, upon obtaining a target image including a plurality of objects at a reference time, first inference for inferring a motion of a tracking target at the reference time on assumptions that the objects are respectively regarded as the tracking target tracked based on time-series images which are obtained before the reference time;
a second inference means for performing second inference for inferring a motion of the tracking target at the reference time based on the time-series images; and
an identification means for identifying an object representing the tracking target among the plurality of objects in the target image, based on inference results of the first inference for the assumptions and an inference result of the second inference.

In an example aspect of the present disclosure, there is provided a tracking method executed by a computer, including:
performing, upon obtaining a target image including a plurality of objects at a reference time, first inference for inferring a motion of a tracking target at the reference time on assumptions that the objects are respectively regarded as the tracking target tracked based on time-series images which are obtained before the reference time;
performing second inference for inferring a motion of the tracking target at the reference time based on the time-series images; and
identifying an object representing the tracking target among the plurality of objects in the target image, based on inference results of the first inference for the assumptions and an inference result of the second inference.

In an example aspect of the present disclosure, there is provided a program executed by a computer, the program causing the computer to:
perform, upon obtaining a target image including a plurality of objects at a reference time, first inference for inferring a motion of a tracking target at the reference time on assumptions that the objects are respectively regarded as the tracking target tracked based on time-series images which are obtained before the reference time;
perform second inference for inferring a motion of the tracking target at the reference time based on the time-series images; and
identify an object representing the tracking target among the plurality of objects in the target image, based on inference results of the first inference for the assumptions and an inference result of the second inference.

An example advantage according to the present disclosure is to accurately identify a tracking target on an image.

### BRIEF DESCRIPTION OF THE DRAWINGS

FIG. 1 illustrates a schematic configuration of a tracking system;

FIG. 2 illustrates a hardware configuration of a tracking device;

FIG. 3 is an example of functional blocks of the tracking device;

FIG. 4A is a diagram schematically illustrating a specific example of processing related to distinguishability determination; FIG. 4B is a table illustrating a degree of overlap on an image of each combination of detected position information and predicted position information;

FIG. 5 illustrates a specific example of input and output of a motion inference model;

FIG. 6A illustrates an outline of processing of generating past image-based motion information of a tracking target allocated with a tracking ID “z”, based on a first generation example;

FIG. 6B illustrates an outline of processing of generating past image-based motion information based on a second generation example;

FIG. 7 illustrates an example of a relationship between each assumption and an inference result output by the motion inference model;

FIG. 8 illustrates an outline of processing of generating past image-based motion information for each of tracking IDs, performed by a motion inference model;

FIG. 9 is a diagram illustrating an outline of matching between the inference result illustrated in FIG. 7 and an inference result illustrated in FIG. 8;

FIG. 10 is an example of a flowchart illustrating a processing procedure executed by the tracking device;

FIG. 11A is a first display example of an image display screen; FIG. 11B is a first display example of a motion score display screen;

FIG. 12A is a second display example of the image display screen; FIG. 12B is a second display example of the motion score display screen;

FIG. 13 is a block diagram of the tracking device; and

FIG. 14 is an example of a flowchart illustrating a processing procedure of the tracking device.

### EXAMPLE EMBODIMENT

Hereinafter, an example embodiment of a tracking device, a tracking method, and a storage medium will be described with reference to the drawings.

### First Example Embodiment

### (1) System Configuration

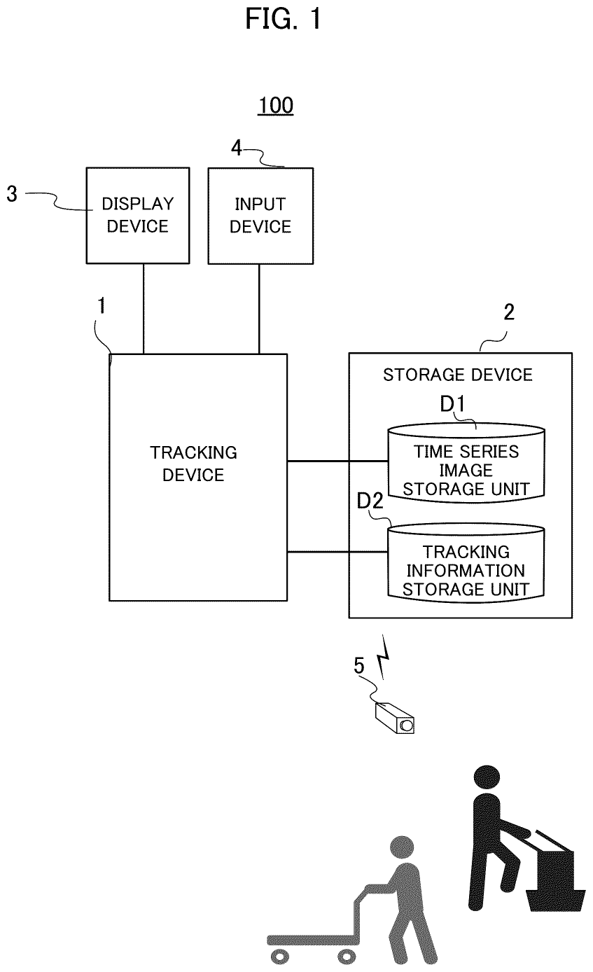

FIG. 1 illustrates a schematic configuration of a tracking system 100. The tracking system 100 is a system that tracks an object based on time-series images, and mainly includes a tracking device 1, a storage device 2, a display device 3, an input device 4, and a camera 5. Hereinafter, a description will be given assuming that an object as a tracking target is a person in general. However, instead of this, the object as the tracking target may be a person having a specific attribute (for example, a gender, an age, or the like), or may be a mobile body of a specific type other than a person (a vehicle, a robot, or the like). “Motion” represents an overall motion of the object, and is assumed to have the same meaning as “action” in a case where the tracking target is a person.

The tracking device 1 manages the tracking target by identifying a correspondence relationship between images of the tracking target as a subject in time-series images captured by the camera 5, and allocating common identification information (also referred to as a “tracking ID”) to the tracking target common between the images. In this case, the tracking device 1 updates information stored in the storage device 2 based on a tracking result. The tracking device 1 may present information based on the tracking result to a user of the tracking system 100 with the display device 3, or may receive an user's input (so-called external input) with the input device 4.

The storage device 2 is a memory that stores various types of information necessary for processing of the tracking device 1, and functionally includes a time-series image storage unit D1 and a tracking information storage unit D2.

The time-series image storage unit D1 stores time-series images generated by the camera 5. The images generated by the camera 5 may be directly supplied to the storage device 2 or may be supplied to the storage device 2 via the tracking device 1 or the like.

The tracking information storage unit D2 stores tracking information, which is information generated by tracking processing performed by the tracking device 1. The tracking information is generated for each image registered in the time-series image storage unit D1, and is associated with the related image. The tracking information includes the tracking ID allocated to each tracking target present in the related image, position information of each tracking target in the image, and motion information representing a motion recognition result of each tracking target. The position information is information representing a region of the tracking target in the image, and is, for example, information representing a bounding box (that is, rectangle information) surrounding the tracking target. The position information in time-series for each tracking ID identified by the tracking information is relevant to trajectory information of the tracking target represented by each tracking ID. The motion information is, for example, information representing a score representing likelihood (that is, a certainty factor) for each motion type (that is, a class of the motion) representing an assumed motion option.

Hereinafter, a latest image supplied from the time-series image storage unit D1 to the tracking device 1 is referred to as a “target image”, and an image obtained before the target image is referred to as a “past image”. That is, the target image is an image to be subjected to processing of associating the tracking information, and the past image is an image to which the tracking information is already associated. For convenience of description, the target image is an image generated at a reference time “t”, and the past image is an image generated at times t-1, t-2,....

The storage device 2 stores information regarding a motion inference model (so-called action recognition device) for inferring a motion of the tracking target. In the present example embodiment, the tracking device 1 selectively uses a plurality of motion inference models according to use. The motion inference model is, for example, a machine learning model, may be a learning model based on a neural network, may be another type of learning model such as a support vector machine, or may be a learning model obtained by combining these. Examples of the motion inference model having a configuration based on a neural network include SlowFast, VideoMAE, and the like. For example, in a case where the motion inference model has a configuration based on a neural network such as a convolutional neural network, the storage device 2 stores information on various parameters such as a layer structure of the motion inference model, a neuron structure of each layer, the number of filters and a filter size in each layer, and a weight of each element of each filter. Details of the motion inference model used by the tracking device 1 will be described later.

The storage device 2 may be an external storage device such as a hard disk connected to or incorporated in the tracking device 1, or may be a storage medium such as a portable flash memory. The storage device 2 may be a server device that performs data communication with the tracking device 1. The storage device 2 may include a plurality of devices.

The display device 3 displays information based on control of the tracking device 1. Examples of the display device 3 include a display, a projector, and the like. Upon receiving a display signal supplied from the tracking device 1, the display device 3 displays information based on the received display signal.

The input device 4 is an interface that receives a user's input that is an external input based on an operation of the user using the tracking system 100, and examples thereof include a touch panel, a button, a keyboard, a voice input device, and the like. The input device 4 supplies an input signal generated based on the user's input to the tracking device 1. The camera 5 is one or a plurality of cameras that capture an image of a range in which the tracking target is to be monitored, and the generated image is stored in the time-series image storage unit D1.

The configuration of the tracking system 100 illustrated in FIG. 1 is an example, and various changes may be made to the configuration. For example, the tracking device 1, the storage device 2, the display device 3, the input device 4, and the camera 5 may be integrally configured by any combination. The tracking system 100 may include a sound output device such as a speaker. The tracking device 1 may include a plurality of devices. In this case, the plurality of devices included in the tracking device 1 exchanges information necessary for executing processing allocated in advance between the plurality of devices.

### (2) Hardware Configuration

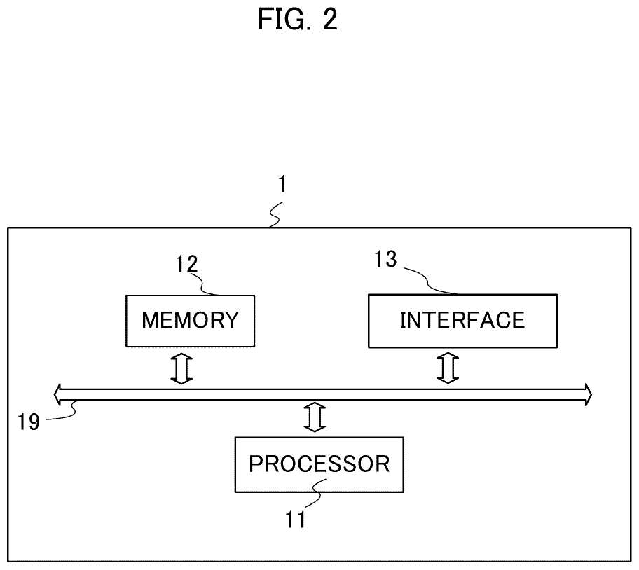

FIG. 2 illustrates a hardware configuration of the tracking device 1. The tracking device 1 includes a processor 11, a memory 12, and an interface 13 as hardware. The processor 11, the memory 12, and the interface 13 are connected via a data bus 19.

The processor 11 executes a predetermined processing by executing a program stored in the memory 12. The processor 11 is a processor such as a central processing unit (CPU), a graphics processing unit (GPU), or a tensor processing unit (TPU). The processor 11 may include a plurality of processors. The processor 11 is an example of a computer.

The memory 12 includes various volatile memories and nonvolatile memories, such as a random access memory (RAM), and a read only memory (ROM). The memory 12 stores a program for the tracking device 1 to execute various types of processing. The memory 12 is used as a working memory, and temporarily stores information and the like acquired from the storage device 2. The memory 12 may function as the storage device 2. Similarly, the storage device 2 may function as the memory 12 of the tracking device 1. The program executed by the tracking device 1 may be stored in a storage medium other than the memory 12.

The interface 13 is an interface for electrically connecting the tracking device 1 and another device. This interface may be a wireless interface such as a network adapter for wirelessly transmitting and receiving data to and from the another device, or may be a hardware interface for connecting to the another device by a cable or the like.

A hardware configuration of the tracking device 1 is not limited to the configuration illustrated in FIG. 2. For example, the tracking device 1 may include at least one of the display device 3 or the input device 4. The tracking device 1 may be connected to or may incorporate a sound output device such as a speaker.

### (3) Outline of Tracking Processing

An outline of processing related to tracking executed by the tracking device 1 will be described. Schematically, the tracking device 1 identifies a person related to a tracking ID based on consistency between inference results, that is, an inference result of a motion in an assumption in which each of a plurality of persons with indistinguishable tracking IDs is tentatively associated with each tracking ID, and an inference result, based on a past image, of a motion of the tracking target indicated by each tracking ID. As a result, in consideration of a transition of the motion, the tracking device 1 achieves robust tracking even in a situation, as in an industrial site, where appearance information is not useful and overlapping of tracking targets occurs.

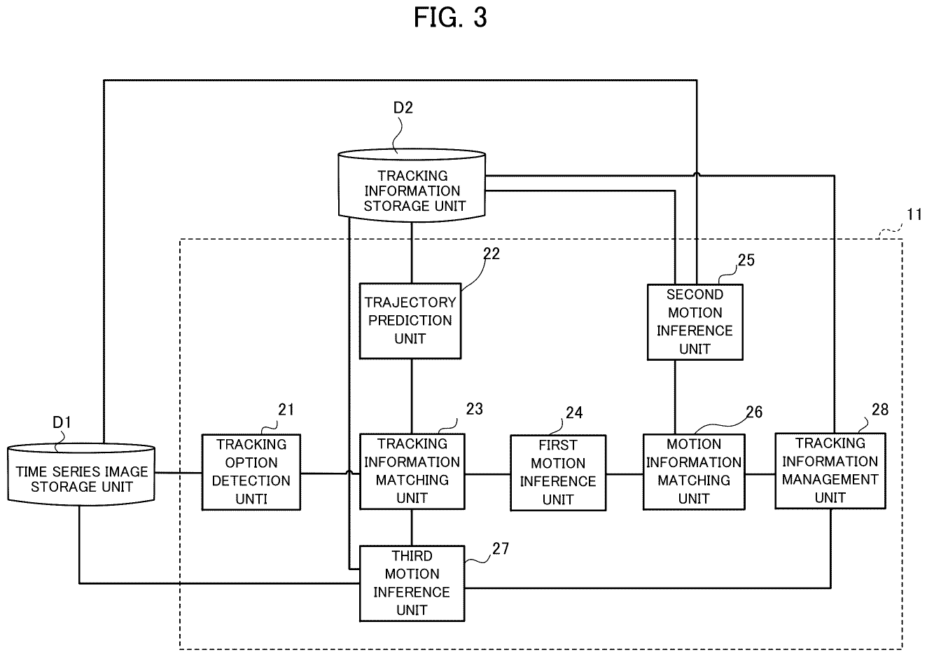

FIG. 3 is an example of functional blocks of the tracking device 1. As illustrated in FIG. 3, the processor 11 of the tracking device 1 functionally includes a tracking option detection unit 21, a trajectory prediction unit 22, a tracking information matching unit 23, a first motion inference unit 24, a second motion inference unit 25, a motion information matching unit 26, a third motion inference unit 27, and a tracking information management unit 28. While blocks that exchange data with each other are connected by a solid line in FIG. 3, a combination of the blocks that exchange data with each other is not limited thereto. The same applies to diagrams of other functional blocks described later.

The tracking option detection unit 21 acquires a target image, which is a latest image generated at the reference time t, from the time-series image storage unit D1, detects a tracking target option (here, a person) from the acquired target image, and generates position information (also referred to as “detected position information”) of the detected option. The detected option (candidate) of the tracking target is hereinafter also referred to as a “tracking option”. In this case, the tracking option detection unit 21 may generate a bounding box surrounding a region of the person based on the target image, by using any object detection model. In this case, the object detection model is, for example, a deep learning model, and is subjected to machine learning to output position information representing a bounding box of a person in an input image when the image is input. Parameters and the like for configuring the object detection model are obtained in advance by machine learning, and stored in the storage device 2 or the like. The tracking option detection unit 21 may detect a region having any shape other than a rectangle for the tracking option, by using an object detection model such as instance segmentation. The tracking option detection unit 21 supplies the target image and the detected position information representing the region of each tracking option, to the trajectory prediction unit 22. The tracking option detection unit 21 extracts past images at times “t-Δ” to “t-1” (Δ is an integer of 2 or more) from the time-series image storage unit D1 in order to use the past images in the subsequent block, and supplies the past images to the trajectory prediction unit 22.

The trajectory prediction unit 22 predicts a position of a person as each tracking target in the target image based on trajectory information on each tracking target to which the tracking ID is allocated. In this case, the trajectory prediction unit 22 refers to the tracking information stored in the tracking information storage unit D2, and identifies the position information of the tracking target in time-series for each tracking ID as the trajectory information. In this case, the trajectory prediction unit 22 may predict, in the target image, a position of a tracking target to which the tracking ID is allocated in the past image, by using any object tracking algorithm using a Kalman filter or the like. Examples of the object tracking algorithm include simple online and realtime tracking (SORT) and ByteTrack. Then, the trajectory prediction unit 22 generates predicted position information indicating a predicted position of a tracking target allocated with each tracking ID in the target image, and supplies the predicted position information of each tracking ID to the tracking information matching unit 23. The predicted position information is information representing a region of the tracking target in the target image, and represents, for example, a bounding box.

The tracking information matching unit 23 compares the predicted position information of each tracking ID generated by the trajectory prediction unit 22 with the detected position information of each tracking option generated by the tracking option detection unit 21, and identifies a tracking option related to each tracking ID. In this case, the tracking information matching unit 23 identifies detected position information most similar to estimated position information of each tracking ID, considers that the identified detected position information is related to a tracking target allocated with the tracking ID at the reference time, and associates the detected position information with the tracking ID. The tracking information matching unit 23 determines whether there is an indistinguishable tracking option in a correspondence relationship with the tracking ID. That is, the tracking information matching unit 23 determines whether there is detected position information representing a plurality of tracking options having a possibility of being related to one tracking ID due to overlapping of positions. A specific example of a method of determining whether being distinguishable will be described later. Then, the tracking information matching unit 23 supplies the detected position information that has been distinguishable in the correspondence relationship with the tracking ID (that is, has been associated with the tracking ID), to the third motion inference unit 27 together with the associated tracking ID and images (the target image and the past image). Whereas, the tracking information matching unit 23 supplies the detected position information representing the indistinguishable tracking option in the correspondence relationship with the tracking ID, to the third motion inference unit 27 together with the image.

For each of the tracking IDs, the first motion inference unit 24 makes an assumption that the indistinguishable tracking option is a tracking target, and generates motion information representing an inference result of a motion of the tracking target at the reference time t in each assumption, based on the target image and the past image. In other words, the first motion inference unit 24 makes an assumption that a possible tracking option for each tracking ID is a tracking target, and generates motion information at the reference time t in each assumption as an inference result. Hereinafter, the motion information at the reference time t in each assumption is also referred to as “assumption-based motion information”.

The first motion inference unit 24 generates the assumption-based motion information by using a motion inference model subjected to the machine learning. In this case, the first motion inference unit 24 generates inference images at times “t-Δ” to “t” showing a tracking target related to each tracking ID, based on past image at times “t-Δ” to “t-1” and the target image at the reference time t. Then, the first motion inference unit 24 infers a motion at the reference time t by using the inference images at the times “t-Δ” to “t” for each tracking ID and using the motion inference model subjected to the machine learning, and generates the assumption-based motion information representing an inference result. The first motion inference unit 24 supplies the assumption-based motion information in each assumption and the detected position information used in each assumption, to the motion information matching unit 26. Hereinafter, the motion inference model used by the first motion inference unit 24 is also referred to as a “motion inference model M1”. The inference images at the times “t-Δ” to “t” are examples of “an image sequence showing a tracking target”.

The second motion inference unit 25 generates, for each tracking ID, motion information (also referred to as “past image-based motion information”) representing a motion of a tracking target at the reference time t based on past images. In this case, the second motion inference unit 25 extracts the past images at the times “t-Δ” to “t-1” from the time-series image storage unit D1, and extracts the position information in each past image associated with each tracking ID from the tracking information storage unit D2. Then, the second motion inference unit 25 generates inference images at the times “t-Δ” to “t-1” for each tracking ID, based on the extracted past images and position information. Then, the second motion inference unit 25 infers a motion at the reference time t by using the inference images at the times “t-Δ” to “t-1” for each tracking ID and using the motion inference model subjected to the machine learning, and generates the past image-based motion information as an inference result thereof. The inference images at the times “t-Δ” to “t-1” are examples of “an image sequence showing a tracking target”.

The motion inference model used by the second motion inference unit 25 is a model that has been machine-learned in advance to output an inference result of a motion of a tracking target in an image (that is, (Δ+1)th image) obtained next to the time-series images, when Δ time-series images of the tracking target are input. As described later, instead of using the past image, the second motion inference unit 25 may infer motion information at the reference time t by extrapolation, based on motion information at the times “t-Δ” to “t-1” stored in the tracking information storage unit D2. The second motion inference unit 25 supplies the past image-based motion information related to each tracking ID to the motion information matching unit 26. Hereinafter, the motion inference model used by the second motion inference unit 25 is also referred to as a “motion inference model M2”.

The motion information matching unit 26 identifies a correspondence relationship between the assumption-based motion information supplied from the first motion inference unit 24 and the past image-based motion information supplied from the second motion inference unit 25. Specifically, the motion information matching unit 26 identifies, for each tracking ID, assumption-based motion information matching (that is, being the most similar to) the past image-based motion information, and determines that the detected position information used to generate the identified assumption-based motion information represents the tracking target allocated with the tracking ID. As a result, the motion information matching unit 26 associates the identified assumption-based motion information with the detected position information for each tracking ID whose related detected position information has been indistinguishable. Then, the motion information matching unit 26 supplies a set of the tracking ID, the motion information, and the detected position information to the tracking information management unit 28 for each tracking ID.

The third motion inference unit 27 infers a motion of the tracking target at the reference time t based on the target image and the past image and based on the position information of the tracking target in the target image and the past image, for each tracking ID associated with the detected position information by the tracking information matching unit 23. In this case, first, the third motion inference unit 27 acquires past images at the times “t-Δ” to “t-1” from the time-series image storage unit D1, and acquires the position information associated with each tracking ID in the past images from the tracking information storage unit D2. Then, based on the acquired past images and position information, the third motion inference unit 27 generates a time-series inference image obtained by cutting out the tracking target of each tracking ID from the past images at the times “t-Δ” to “t-1”. The third motion inference unit 27 generates an inference image obtained by cutting out the tracking target for each tracking ID from the target image, based on the target image and the detected position information of the tracking option related to each tracking ID in the target image. As a result, the third motion inference unit 27 acquires inference images at the times “t-Δ” to “t” for each tracking ID. Then, the third motion inference unit 27 infers a motion at the reference time t for each tracking ID by using the inference images at the times “t-Δ” to “t” and using a motion inference model subjected to the machine learning, and generates motion information representing an inference result thereof. The motion inference model in this case is a model that has been machine-learned in advance to output an inference result of a motion of a person in a last image among input time-series images, when a predetermined number (here, Δ+1) of time-series images showing the specific person are input. Then, the third motion inference unit 27 supplies a set of the tracking ID, the motion information at the reference time t, and the detected position information to the tracking information management unit 28. Hereinafter, the motion inference model used by the third motion inference unit 27 is also referred to as a “motion inference model M3”.

The third motion inference unit 27 may further execute processing of allocating a new tracking ID to detected position information of a tracking option that is not related to any tracking ID, and processing of inferring a motion of a tracking target allocated with the newly allocated tracking ID based on the target image. In this case, the third motion inference unit 27 supplies a set of the newly allocated tracking ID, the detected position information, and the motion information inferred based on the target image, to the tracking information management unit 28.

The tracking information management unit 28 updates the tracking information storage unit D2 based on the information supplied from the motion information matching unit 26 and the third motion inference unit 27. Specifically, the motion information and the detected position information at the reference time t are added to the tracking information for each tracking ID registered in the tracking information storage unit D2. In this case, the tracking information management unit 28 updates the tracking information of the tracking ID determined to be distinguishable by the tracking information matching unit 23, based on the information supplied from the third motion inference unit 27, and updates the tracking information of the tracking ID determined to be indistinguishable by the tracking information matching unit 23, based on the information supplied from the motion information matching unit 26.

Here, each component of the tracking option detection unit 21, the trajectory prediction unit 22, the tracking information matching unit 23, the first motion inference unit 24, the second motion inference unit 25, the motion information matching unit 26, the third motion inference unit 27, and the tracking information management unit 28 can be implemented by, for example, the processor 11 executing a program. Each component may also be achieved by recording a necessary program in an optional nonvolatile storage medium and installing the program as necessary. At least a part of these components is not limited to be achieved by software by a program, and may be achieved by a combination of any of hardware, firmware, and software, or the like. At least a part of these components may be achieved using, for example, a user-programmable integrated circuit such as a field-programmable gate array (FPGA) or a microcontroller. In this case, a program including the above components may be achieved by using the integrated circuit. At least a part of the components may include an application specific standard produce (ASSP), an application specific integrated circuit (ASIC), or a quantum processor (quantum computer control chip). In this manner, the components may be achieved by various types of hardware. The same applies to other example embodiments described later. These components may also be achieved by, for example, cooperation of a plurality of computers by using a cloud computing technology or the like.

### (4) Distinguishability Determination

Next, a specific example of distinguishability determination, which is determination on distinguishability of detected position information associated with a tracking ID, will be described.

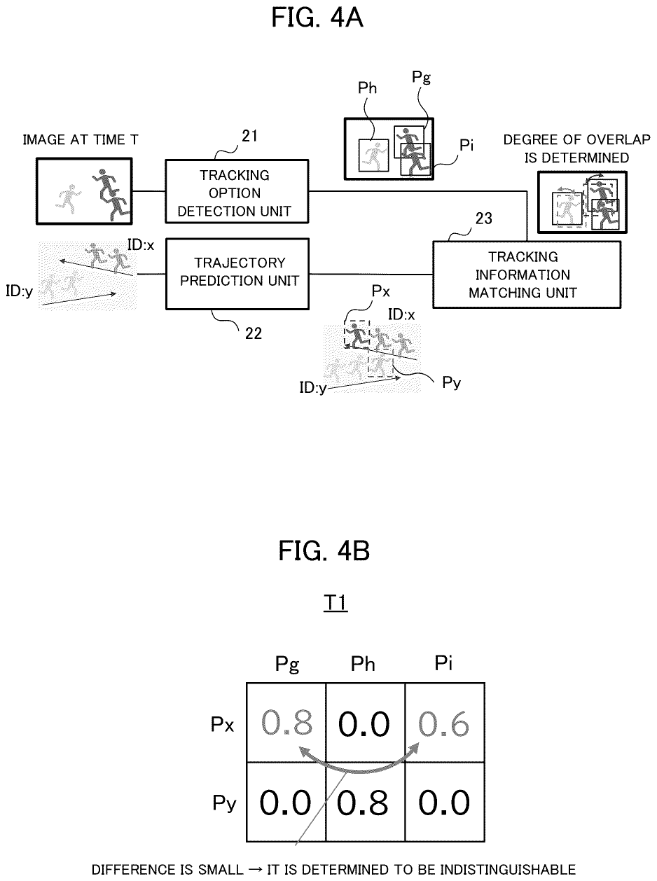

FIG. 4A is a diagram schematically illustrating a specific example of processing related to the distinguishability determination. FIG. 4A illustrates a specific example of the distinguishability determination when a target image at the reference time t at which there are a plurality of persons overlapping on an image is obtained. Here, it is assumed that tracking targets whose tracking IDs are “x” and “y” are being tracked in the past images.

In this case, the tracking option detection unit 21 generates detected position information related to three tracking options based on the target image. Here, pieces of detected position information related to the three tracking options are represented by bounding boxes Pg, Ph, and Pi. The trajectory prediction unit 22 generates predicted position information of the tracking IDs “x” and “y” at the reference time t, based on the position information of the tracking IDs “x” and “y” in the past images. Here, pieces of the predicted position information of the tracking IDs “x” and “y” are represented by bounding boxes Px and Py.

Then, the tracking information matching unit 23 calculates a degree of overlap of a pair of bounding boxes individually extracted from the bounding boxes Pg, Ph, and Pi representing the detected position information and the bounding boxes Px and Py representing the predicted position information. Here, the degree of overlap is a degree of overlap of the bounding boxes on the image, and an index such as IoU is used, for example. Note that, in a case where the position information is information based on a posture of an object (for example, position information of a joint serving as a key), an index such as object keypoint similarity (OKS) may be used as the degree of overlap.

FIG. 4B is a table T1 illustrating a degree of overlap on an image of a pair of bounding boxes individually extracted from the bounding boxes Pg, Ph, and Pi representing the detected position information and the bounding boxes Px and Py representing the predicted position information. Here, the degree of overlap is shown by a value range between a minimum value 0 and a maximum value 1. Then, for the bounding box Px, the degree of overlap with the bounding box Pg is 0.8, and the degree of overlap with the bounding box Pi is 0.6, and these values are approximate. Therefore, the tracking information matching unit 23 determines that the detected position information related to each of the bounding boxes Pg and Pi is indistinguishable in the correspondence relationship with the tracking ID “x”.

Specifically, first, the tracking information matching unit 23 determines each piece of detected position information matching (consistent with) the predicted position information for each tracking ID, based on a matching method such as the Hungarian algorithm. Next, a degree of overlap between the detected position information and the predicted position information (in this case, the degree of overlap between the bounding boxes) is defined as “O”, and a degree of overlap of the detected position information matching the predicted position information is defined as “Om”. Then, in a case where there is detected position information for which the degree of overlap O is equal to or more than a predetermined threshold and the degree of overlap O satisfies the following formula in relation to the degree of overlap Om, the tracking information matching unit 23 determines that the detected position information is indistinguishable from the matched detected position information.

$$Om > O > Om - s ,$$

where s is a real number

For example, it is assumed that the predetermined threshold is “0.5”, the real number s is “0.3”, and the bounding box Px representing the predicted position information matches the bounding box Pg representing the detected position information. In this case, the degree of overlap Om of the bounding box Px is 0.8, the degree of overlap O (=0.6) of the bounding box Pi is equal to or more than the threshold 0.5, and “0.8>O>0.5 (=0.8-0.3)” is satisfied, and the formula mentioned above is satisfied. Therefore, the tracking information matching unit 23 determines that the detected position information related to the bounding boxes Pg and Pi is indistinguishable.

### (5) Generation of Assumption-Based Motion Information

Next, generation of assumption-based motion information performed by the first motion inference unit 24 will be specifically described.

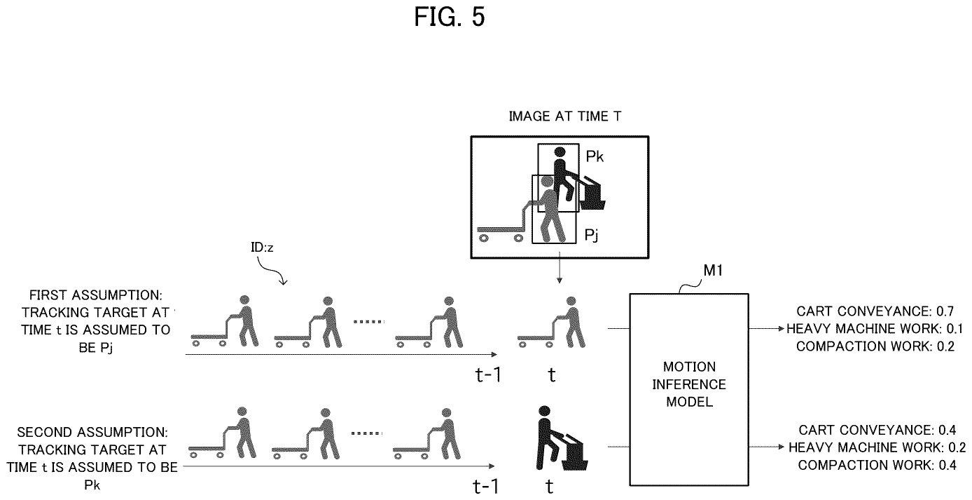

FIG. 5 illustrates a specific example of input and output of the motion inference model M1 used by the first motion inference unit 24. In FIG. 5, it is assumed that two bounding boxes Pj and Pk representing tracking options for an image at the reference time t are obtained as the detected position information, and the detected position information represented by these bounding boxes Pj and Pk has a possibility of being related to a tracking target allocated with the tracking ID “z”, and is determined to be indistinguishable by the tracking information matching unit 23.

In this case, the first motion inference unit 24 sets a first assumption and a second assumption. In the first assumption, the tracking target allocated with the tracking ID “z” at the reference time t is assumed to be represented by the detected position information related to the bounding box Pj. In the second assumption, the tracking target allocated with the tracking ID “z” at the reference time t is assumed to be represented by the detected position information related to the bounding box Pk. Then, by using the motion inference model M1, the first motion inference unit 24 acquires an inference result of a motion at the reference time t based on the first assumption and an inference result of a motion at the reference time t based on the second assumption. In this case, the first motion inference unit 24 generates time-series inference images based on each assumption, and inputs the time-series inference images to the motion inference model M1 to acquire the inference result output from the motion inference model M1. Here, the first motion inference unit 24 generates the inference image at the reference time t in the first assumption based on the target image and the bounding box Pj, and generates the inference image at the reference time t in the second assumption based on the target image and the bounding box Pk. The first motion inference unit 24 generates inference images at the times “t-Δ” to “t-1” to be used in each assumption, based on past images at the times “t-Δ” to “t-1” and position information associated with the past images.

Here, the motion inference model M1 outputs, as the inference result, a sequence of scores (that is, a score vector) representing likelihood of an assumed motion type (that is, a class of the motion). Here, examples of the assumed motion type include “cart conveyance”, “heavy machine work”, and “compaction work”. Then, the first motion inference unit 24 uses the score vector output by the motion inference model M1 as the assumption-based motion information. The assumption-based motion information may be scores of all motion types output by the motion inference model M1, or may be scores of motion types with scores among a predetermined number of top scores.

Here, the motion inference model M1 is, for example, a neural network subjected to machine learning, and examples of such a neural network include SlowFast, VideoMAE, and the like. Time-series inference images to be input to the motion inference model M1 may be time-series images obtained by cutting out a region of the tracking target (for example, a bounding box is cropped), time-series images obtained by cutting out a region of an object around the tracking target, such as a tool used by the tracking target, or time-series posture information of the tracking target. The posture information in this case is position information of a joint point of a person as the tracking target on the image.

### (6) Generation of Past Image-Based Motion Information

Next, a description is given to a first generation example and a second generation example, which are generation examples of past image-based motion information by the second motion inference unit 25.

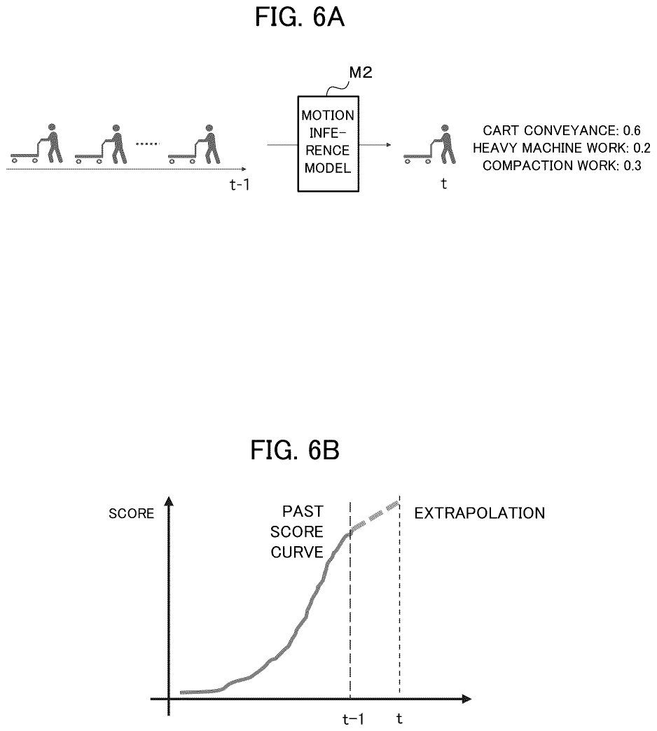

FIG. 6A illustrates an outline of processing of generating past image-based motion information of a tracking target allocated with a tracking ID “z”, based on the first generation example.

In the first generation example, the second motion inference unit 25 generates inference images at times “t-Δ” to “t-1”, based on past images at the times “t-Δ” to “t-1” and related position information of the tracking ID “z”. Then, by using the motion inference model M2, the second motion inference unit 25 acquires an inference result output from the motion inference model M2 by inputting the time-series inference images to the motion inference model M2. In this case, the inference result output by the motion inference model M2 is data in the same format as the inference result output by the motion inference model M1, and is, for example, a score vector of an assumed motion type. Then, the second motion inference unit 25 uses the score vector output by the motion inference model M2 as past image-based motion information. The past image-based motion information may be scores of all motion types output by the motion inference model M2, or may be scores of motion types with scores among a predetermined number of top scores The motion inference model M2 is, for example, a neural network subjected to machine learning, and examples of such a neural network include SlowFast, VideoMAE, and the like. Time-series inference images to be input to the motion inference model M2 may be time-series images obtained by cutting out a region of the tracking target, time-series images obtained by cutting out a region of an object around the tracking target, such as a tool used by the tracking target, or time-series posture information of the tracking target.

FIG. 6B illustrates an outline of processing of generating past image-based motion information based on the second generation example. Specifically, FIG. 6B illustrates a distribution of scores of a certain motion type.

In the second generation example, the second motion inference unit 25 extracts motion information of the tracking ID “z” at the times “t-Δ” to “t-1” from the tracking information storage unit D2 instead of using the inference image, and obtains a score at the reference time t by extrapolation, based on time-series scores represented by the extracted motion information. In this case, for example, the second motion inference unit 25 infers a score at the reference time t from the scores at the times “t-Δ” to “t-1” for each motion type. In this case, the motion inference model M2 is an algorithm that implements any given extrapolation method, and is a model that outputs motion information at the reference time t when motion information (that is, a score vector) at the times “t-Δ” to “t-1” is input.

Also in the second generation example, the second motion inference unit 25 can generate a score vector at the reference time t based on a past score vector. Then, the tracking device 1 can achieve matching robust to a transition of a motion, by predicting a future motion of the tracking target with the first generation example or the second generation example.

### (7) Matching of Motion Information

Next, matching between the assumption-based motion information and the past image-based motion information performed by the motion information matching unit 26 will be specifically described. The motion information matching unit 26 calculates a cost according to a similarity between the score vector indicated by the assumption-based motion information and the score vector indicated by the past image-based motion information, and determines matching between the assumption-based motion information and the past image-based motion information to minimize the cost. The cost in this case is any index value (a cosine similarity, an L2 norm, or the like) representing a similarity between vectors or a reciprocal of the index value, and is set to be higher as the score vectors are similar to each other, for example. The matching between the assumption-based motion information and the past image-based motion information is determined, for example, by any matching method such as a Hungarian algorithm. Then, as detected position information at the reference time t, for each tracking ID, the motion information matching unit 26 adopts detected position information used in the assumption of the assumption-based motion information matching the past image-based motion information.

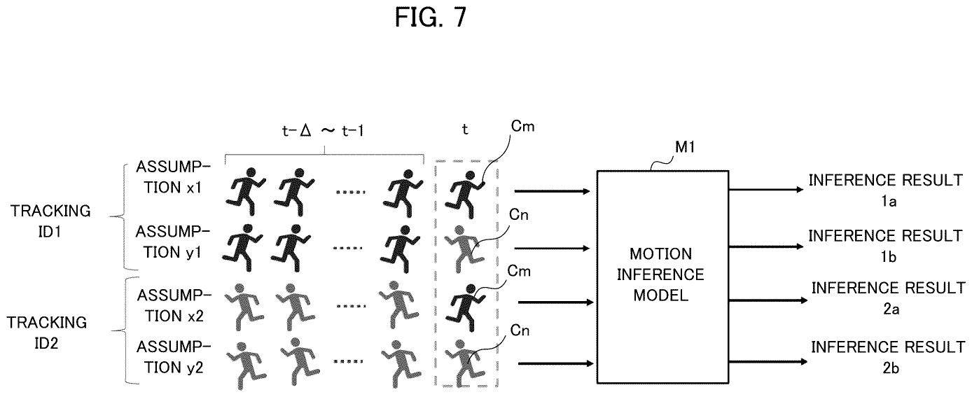

FIG. 7 illustrates an example of a relationship between each set assumption and an inference result output by the motion inference model M1. Here, there are tracking options Cm and Cn related to indistinguishable detected position information regarding a tracking ID 1 and a tracking ID 2. The first motion inference unit 24 sets assumptions x1, y1, x2, and y2 in which the tracking options Cm and Cn are assumed to represent the tracking targets allocated with the tracking ID 1 and the tracking ID 2, respectively, and acquires inference results 1a, 1b, 2a, and 2b related to the respective assumptions, from the motion inference model M1. Each of these inference results is relevant to assumption-based motion information.

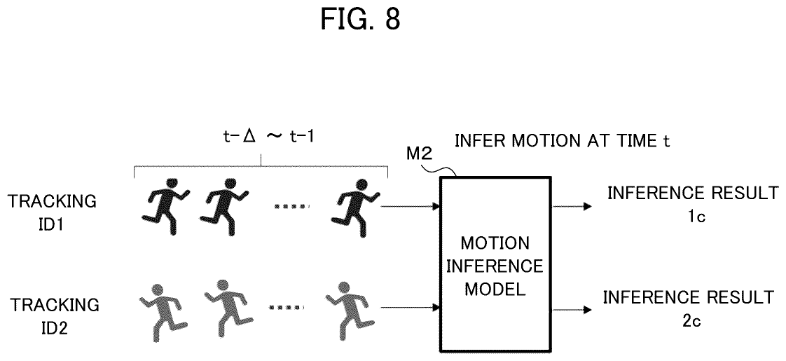

FIG. 8 illustrates an outline of processing of generating past image-based motion information performed by the motion inference model M2 for each of the tracking ID 1 and the tracking ID 2. In the example of FIG. 8, the first motion inference unit 24 acquires inference results 1c and 2c output by the motion inference model M2, by inputting time-series images of the tracking target based on past images at the times “t-Δ” to “t-1” to the motion inference model M2 for each of the tracking ID 1 and the tracking ID 2. The inference results 1c and 2c are relevant to past image-based motion information.

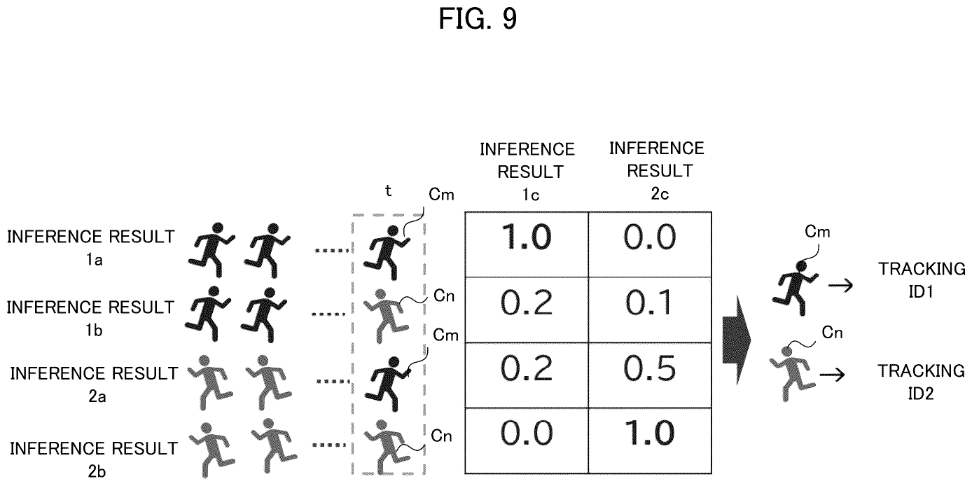

FIG. 9 is a diagram illustrating an outline of matching between the inference result illustrated in FIG. 7 and the inference result illustrated in FIG. 8. In this case, the motion information matching unit 26 calculates a cost based on a similarity of the score vectors for all combinations of the inference results 1a, 1b, 2a, and 2b and the inference results 1c and 2c. A matrix illustrated in FIG. 9 represents costs of related inference result combinations. Here, each the cost of the inference result 1c and the inference result 1a and the cost of the inference result 2c and the inference result 2b is the maximum value 1.0, and the motion information matching unit 26 determines that the inference result 1c of the tracking ID “1” matches the inference result 1a of the assumption x1, and the inference result 2c of the tracking ID“ 2” matches the inference result 2b of the assumption y2. Therefore, the motion information matching unit 26 adopts the assumption x1 and the assumption y2, and determines that the tracking option Cm is the tracking target allocated with the tracking ID 1 at the reference time t and the tracking option Cn is the tracking target allocated with the tracking ID 2 at the reference time t.

In this way, by taking the motion information into consideration in the matching of the tracking IDs and distinguishing information on persons in more detail, it is possible to achieve robust tracking even in a situation where overlap between the persons occurs. In other words, by introducing a matching method in consideration of a transition of a motion, it is possible to achieve robust tracking even in a situation, as in an industrial site, where appearance information is not useful and overlapping of persons occurs.

### (8) Processing Flow

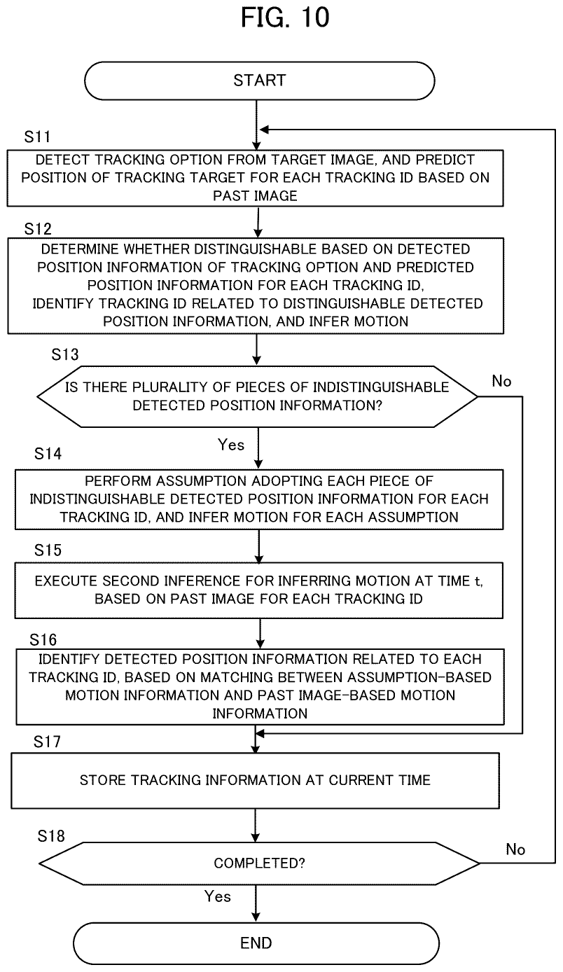

FIG. 10 is an example of a flowchart illustrating a processing procedure executed by the tracking device 1.

First, the tracking device 1 detects a tracking option from a target image at the reference time t corresponding to the current processing time, and predicts a position of a tracking target at the reference time t for each tracking ID based on past images (step S11). As a result, the tracking device 1 generates detected position information of the tracking option existing in the target image and predicted position information for each tracking ID. The processing in step S11 is relevant to the processing executed by the tracking option detection unit 21 and the trajectory prediction unit 22.

Next, the tracking device 1 executes the distinguishability determination based on the detected position information of the tracking option and the predicted position information for each tracking ID, identifies a tracking ID related to distinguishable detected position information, and infers a motion at the reference time t for the identified tracking ID (step S12). The processing in step S12 is relevant to the processing executed by the tracking information matching unit 23 and the third motion inference unit 27.

Next, the tracking device 1 determines whether there are a plurality of pieces of indistinguishable detected position information (step S13). Then, in a case where a plurality of pieces of indistinguishable detected position information are not present (step S13; No), tracking information at the reference time t based on a processing result in step S12 is stored in the tracking information storage unit D2 (step S17).

Whereas, in a case where there are a plurality of pieces of indistinguishable detected position information (step S13; Yes), the tracking device 1 infers a motion at the reference time t for each assumption by making the assumption adopting each piece of indistinguishable detected position information for each tracking ID (step S14). As a result, the tracking device 1 generates assumption-based motion information. The processing in step S14 is relevant to the processing executed by the first motion inference unit 24. Then, the tracking device 1 infers a motion at the reference time t based on the past image for each tracking ID (step S15). As a result, the tracking device 1 generates past image-based motion information. The processing in step S15 is relevant to the processing executed by the second motion inference unit 25.

Then, the tracking device 1 identifies the detected position information related to the tracking ID for which the related detected position information has not been identifiable in step S12, based on matching (comparison) between the assumption-based motion information and the past image-based motion information (step S16). In this case, the tracking device 1 identifies, for each tracking ID, the detected position information adopted to generate the assumption-based motion information matching the past image-based motion information. The processing in step S16 is relevant to the processing executed by the motion information matching unit 26. Then, the tracking device 1 stores the tracking information at the reference time t in the tracking information storage unit D2 (step S17). The processing in step S17 is relevant to the processing executed by the tracking information management unit 28.

Next, the tracking device 1 determines whether to end the tracking processing (step S18). Then, in a case where the tracking device 1 determines to end the tracking processing (step S18; Yes), the processing of the flowchart is ended. Whereas, in a case where the tracking device 1 determines not to end the tracking processing (step S18; No), an image newly obtained from the camera 5 is used as the target image obtained at the reference time t, and the processing returns to step S11.

### (9) Application Example

According to the example embodiment above, latest tracking information based on images generated by the camera 5 is accumulated in the storage device 2, and the tracking system 100 can automatically record an action of a person. By analyzing such tracking information, a work action of each worker can be visualized, enabling improvement of productivity and improvement of safety. The improvement of productivity includes work record automation, finding a work delay and a mistake, work efficiency analysis, personnel allocation optimization, other work efficiency improvement, and the like. The improvement of safety includes alert for unsafe actions, near miss monitoring, prevention of other work injuries, and the like. In a warehouse, manufacturing, and construction industries, it is possible to accurately grasp a motion of each worker based on the tracking information, and to optimize personnel resources. In the manufacturing and warehouse industries, a motion of each worker can be accurately grasped based on the tracking information, and can be used for work guarantee and education support. In the warehouse and manufacturing industries, it is also conceivable to grasp time-series motions of a work body (including a robot), and utilize the result for automation of article handling.

The tracking device 1 may display information regarding a tracking target in real time based on the tracking information. Hereinafter, a specific example of display processing in real time will be described.

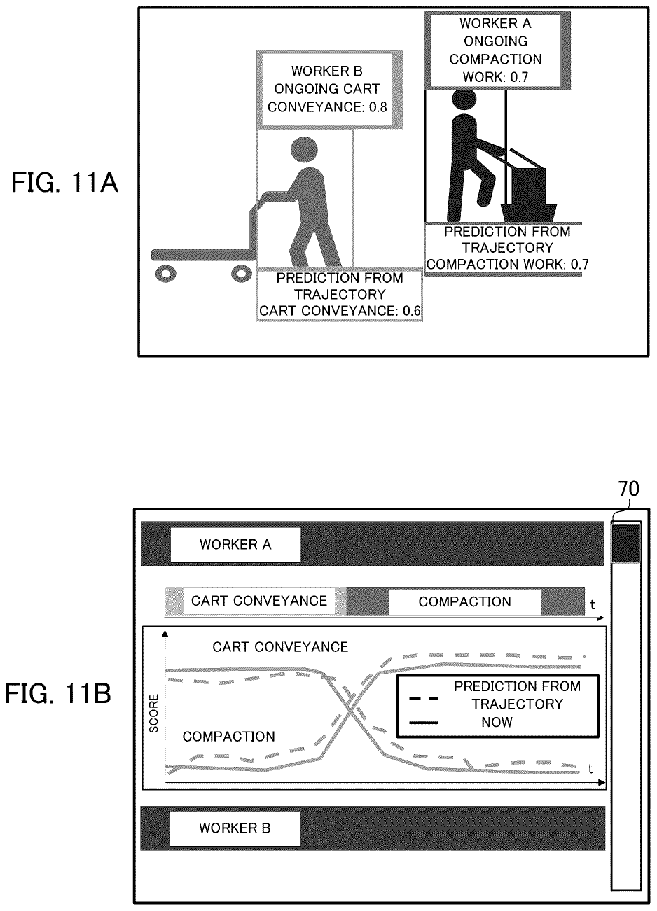

FIG. 11A is a first display example of an image display screen showing a latest image generated by the camera 5, and FIG. 11B is a first display example of a motion score display screen showing a transition of a score of a motion for each worker as a tracking target. The tracking device 1 causes the display device 3 to display at least either of the image display screen and the motion score display screen, by generating display information with reference to the time-series image storage unit D1 and the tracking information storage unit D2, and transmits the generated display information to the display device 3.

On the image display screen illustrated in FIG. 11A, for each of a worker A and a worker B as tracking targets to which tracking IDs are allocated, the tracking device 1 displays scores based on assumption-based motion information and past image-based motion information, regarding identified motions. Specifically, in association with the worker A on the image, the tracking device 1 shows that the worker A is performing the “compaction work”, based on the tracking information of the worker A related to the reference time. The tracking device 1 displays, in association with the worker A, a score based on the past image-based motion information (relevant to “prediction from a trajectory, compaction work: 0.7”) and a score based on the matched assumption-based motion information (relevant to “current, compaction work: 0.7”). Similarly, in association with the worker B, the tracking device 1 shows that the worker B is performing the “cart conveyance” on the image, based on the tracking information related to the reference time. Further, the tracking device 1 displays, in association with the worker B, a score based on the past image-based motion information (relevant to “prediction from a trajectory, cart conveyance: 0.6”) and a score based on the matched assumption-based motion information (relevant to “current, cart conveyance: 0.8”).

By displaying such an image display screen, the tracking device 1 can allow the user to grasp an inference result of a current work type of a worker in detail together with a score representing likelihood of the inference result.

The motion score display screen illustrated in FIG. 11B graphically represents time-series scores representing likelihood of each work type for each worker. Here, a graph marked “prediction from a trajectory” with a broken line is relevant to a graph representing a temporal change in the score based on the past image-based motion information, and a graph marked “current” with a solid line is relevant to a graph representing a temporal change in the score based on the assumption-based motion information. In FIG. 11B, a work type having a highest score is indicated along an arrow representing a time axis on the graph. In the case of the worker A, “compaction” is written after the “cart conveyance”. In the motion score display screen, a scroll bar 70 is provided, and a graph related to any worker as the tracking target can be displayed by operating the scroll bar 70.

By displaying such a motion score display screen, the tracking device 1 can allow the user to check the inference result in time-series of the work type of any worker.

The tracking device 1 may further execute processing of predicting a future work type, and display a prediction result of the work type on the image display screen and the motion score display screen.

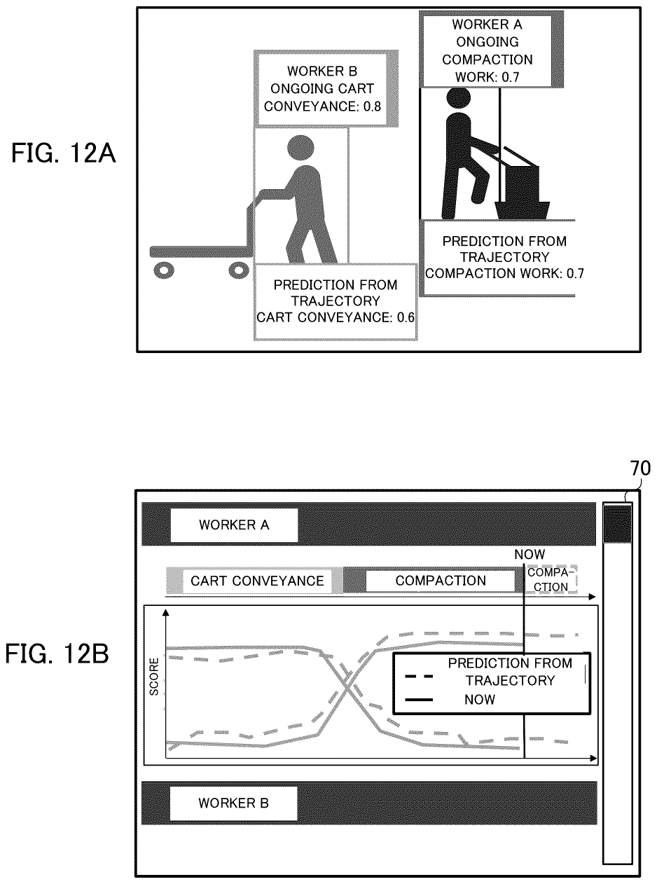

FIG. 12A illustrates a second display example of the image display screen, and FIG. 12B illustrates a second display example of the motion score display screen. On the image display screen illustrated in FIG. 12A, for each of the worker A and the worker B, the tracking device 1 predicts a motion at a time (for example, a time t +1) after the reference time t based on the detected position information of the worker A and the worker B at the reference time t, and displays a score based on the motion information representing the predicted motion as “future prediction from a trajectory”. For example, in a case where the motion inference model M2 is a model for predicting a motion based on time-series images, the tracking device 1 generates Δ time-series inference images based on the motion information and images for the past Δ times including the reference time t. Then, the tracking device 1 inputs the generated inference images to the motion inference model M2, to acquire motion information at a future time output by the motion inference model M2. In a case where the motion inference model M2 is a model for performing extrapolation, the tracking device 1 acquires the motion information at the future time based on the motion information relevant to the past Δ times including the reference time t and based on the motion inference model M2. Similarly to the image display screen of the first display example, the tracking device 1 shows, on the image, that the worker A is executing the “compaction work” and the worker B is executing the “cart conveyance” in association with each worker, based on the tracking information related to the reference time t. The tracking device 1 displays, on the image, the score “0.7” of the current “compaction work” in association with the worker A and the score “0.8” of the current “cart conveyance” in association with the worker B, based on the motion information (assumption-based motion information) at the reference time t.

The motion score display screen illustrated in FIG. 12B graphically represents time-series scores representing likelihood of each work type for each worker. Here, a graph marked “prediction from a trajectory” with a broken line is relevant to a graph representing a temporal change in the score based on the past image-based motion information and the predicted motion information, and a graph marked “current” with a solid line is relevant to a graph representing a temporal change in the score based on the assumption-based motion information. As illustrated in FIG. 12B, the graph marked “prediction from a trajectory” also illustrates predicted values of scores after the reference time. By displaying the motion score display screen according to the second display example, the tracking device 1 can allow the user to check the inference result in time-series including the future prediction of the work type of any worker.

### Second Example Embodiment

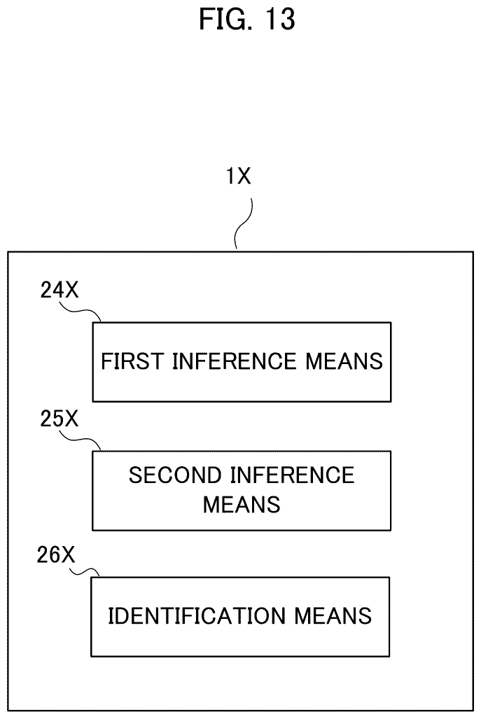

FIG. 13 is a block diagram of a tracking device 1X. The tracking device 1X includes a first inference means 24X, a second inference means 25X, and an identification means 26X. The tracking device 1X may be configured by plural devices.

The first inference means 24X is configured to perform, upon obtaining a target image including a plurality of objects at a reference time, first inference for inferring a motion of a tracking target at the reference time on assumptions that the objects are respectively regarded as the tracking target tracked based on time-series images which are obtained before the reference time. In other words, if the target image at the reference time includes first to Nth (N is an integer of 2 or more) objects, the first inference means 24X assumes that the tracking target at the reference time is an object selected from the first to Nth objects in sequence, and then infers N patterns of motions for each tracking target. Examples of the first inference means 24X include the first motion inference unit 24 according to the first example embodiment.

The second inference means 25X is configured to perform second inference for inferring a motion of the tracking target at the reference time based on the time-series images. In this case, the second inference means 25X infers a single pattern of motion for a single tracking target. Examples of the second inference means 25X include the second motion inference unit 25 according to the second example embodiment.

The identification means 26X is configured to identify an object representing the tracking target among the plurality of objects in the target image, based on inference results of the first inference for the assumptions and an inference result of the second inference. In this case, the identification means 26X identifies an object among the first to Nth objects as the tracking target. Examples of the identification means 26X include the motion information matching unit 26 according to the first example embodiment.

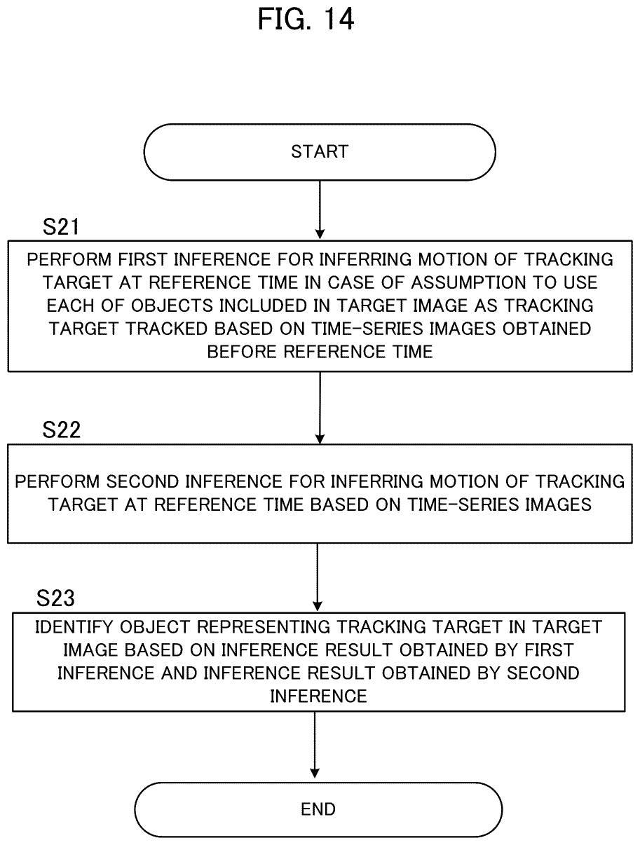

FIG. 14 illustrates an example of a flowchart indicative of the procedure of the process executed by the tracking device 1X. First, the first inference means 24X performs, upon obtaining a target image including a plurality of objects at a reference time, first inference for inferring a motion of a tracking target at the reference time on assumptions that the objects are respectively regarded as the tracking target tracked based on time-series images which are obtained before the reference time (step S21). Next, the second inference means 25X performs second inference for inferring a motion of the tracking target at the reference time based on the time-series images (step S22). Then, the identification means 26X identifies an object representing the tracking target among the plurality of objects in the target image, based on inference results of the first inference for the assumptions and an inference result of the second inference (step S23).

According to the second example embodiment, the tracking device 1X can robustly track an object even under such a situation where apparent information is not useful and objects overlap with each other on the image.

In the example embodiments described above, the program is stored by any type of a non-transitory computer-readable medium (non-transitory computer readable medium) and can be supplied to a control unit or the like that is a computer. The non-transitory computer-readable medium include any type of a tangible storage medium. Examples of the non-transitory computer readable medium include a magnetic storage medium (e.g., a flexible disk, a magnetic tape, a hard disk drive), a magnetic-optical storage medium (e.g., a magnetic optical disk), CD-ROM (Read Only Memory), CD-R, CD-R/W, a solid-state memory (e.g., a mask ROM, a PROM (Programmable ROM), an EPROM (Erasable PROM), a flash ROM, a RAM (Random Access Memory)). The program may also be provided to the computer by any type of a transitory computer readable medium. Examples of the transitory computer readable medium include an electrical signal, an optical signal, and an electromagnetic wave. The transitory computer readable medium can provide the program to the computer through a wired channel such as wires and optical fibers or a wireless channel.

In addition, some or all of the above-described example embodiments may also be described as following Supplementary Notes, but are not limited to the following. All or a part of the configuration described in Supplementary Notes 2 to 9 which depend on Supplementary Note 1 can also be applied to Supplementary Notes 10 and 11 in the same dependent relationship. Furthermore, within the range defined by the above-described example embodiments, regardless of the device, method, and storage medium described in the following Supplementary Notes, some or all of the configurations described in the following Supplementary Notes may be applied to any hardware, software, system and recording means (including the storage medium) for recording a software.

### [Supplementary Note 1]

A tracking device comprising:
a first inference means for performing, upon obtaining a target image including a plurality of objects at a reference time, first inference for inferring a motion of a tracking target at the reference time on assumptions that the objects are respectively regarded as the tracking target tracked based on time-series images which are obtained before the reference time;
a second inference means for performing second inference for inferring a motion of the tracking target at the reference time based on the time-series images; and
an identification means for identifying an object representing the tracking target among the plurality of objects in the target image, based on inference results of the first inference for the assumptions and an inference result of the second inference.

### [Supplementary Note 2]

The tracking device according to Supplementary Note 1, wherein the identification means identifies an inference result most similar to the inference result of the second inference among the inference results for the assumptions, and identifies the object representing the tracking target based on an assumption related to the identified inference result among the assumptions.

### [Supplementary Note 3]

The tracking device according to Supplementary Note 1, further comprising:
a determination means for determining whether or not the tracking target is distinguishable among the plurality of objects, wherein
the first inference means performs the first inference upon determining that the tracking target is distinguishable.

### [Supplementary Note 4]

The tracking device according to Supplementary Note 3, further comprising:
an object detection means for detecting regions of the plurality of objects from the target image, wherein
the determination means determines, based on a degree of overlap of the regions, whether or not the tracking target is distinguishable.

### [Supplementary Note 5]

The tracking device according to Supplementary Note 1, wherein
the first inference means generates a sequence of images showing the tracking target based on the time-series images and the target image for each of the assumptions, and infer a motion at the reference time based on the sequence of images and a machine learning model, and
the machine learning model is a model subjected to machine learning to output an inference result of a motion of an object upon taking, as an input, time-series images showing the object.

### [Supplementary Note 6]

The tracking device according to Supplementary Note 1, wherein the second inference means infers a motion at the reference time by extrapolation, based on motion information representing a motion of the tracking target before the reference time, the motion information being generated based on the time-series images.

### [Supplementary Note 7]

The tracking device according to Supplementary Note 1, wherein
the second inference means generates a sequence of images showing the tracking target based on the time-series images, and infers a motion at the reference time based on the sequence of images and a machine learning model, and
the machine learning model is a model subjected to machine learning to output an inference result of a predicted motion of an object upon taking, as an input, time-series images showing the object.

### [Supplementary Note 8]

The tracking device according to Supplementary Note 1, further comprising: a display control means for causing a display device to display the object identified as the tracking target on the target image in association with information representing a motion of the object, based on at least either of the inference results for the assumptions and the inference result of the second inference.

### [Supplementary Note 9]

The tracking device according to Supplementary Note 1, wherein each of the inference results for the assumptions and the inference result of the second inference indicates a plurality of scores representing probabilities for respective possible motion types.

### [Supplementary Note 10]

A data analysis method executed by a computer, comprising:
performing, upon obtaining a target image including a plurality of objects at a reference time, first inference for inferring a motion of a tracking target at the reference time on assumptions that the objects are respectively regarded as the tracking target tracked based on time-series images which are obtained before the reference time;
performing second inference for inferring a motion of the tracking target at the reference time based on the time-series images; and
identifying an object representing the tracking target among the plurality of objects in the target image, based on inference results of the first inference for the assumptions and an inference result of the second inference.

### [Supplementary Note 11]

A program executed by a computer, the program causing the computer to:
perform, upon obtaining a target image including a plurality of objects at a reference time, first inference for inferring a motion of a tracking target at the reference time on assumptions that the objects are respectively regarded as the tracking target tracked based on time-series images which are obtained before the reference time;
perform second inference for inferring a motion of the tracking target at the reference time based on the time-series images; and
identify an object representing the tracking target among the plurality of objects in the target image, based on inference results of the first inference for the assumptions and an inference result of the second inference.

### [Supplementary Note 12]

A non-transitory computer readable storage medium storing the program according to Supplementary Note 11.

While the invention has been particularly shown and described with reference to example embodiments thereof, the invention is not limited to these example embodiments. It will be understood by those of ordinary skilled in the art that various changes in form and details may be made therein without departing from the spirit and scope of the present invention as defined by the claims. In other words, it is needless to say that the present invention includes various modifications that could be made by a person skilled in the art according to the entire disclosure including the scope of the claims, and the technical philosophy. Each example embodiment can be appropriately combined with other example embodiments. All Patent and Non-Patent Literatures mentioned in this specification are incorporated by reference in its entirety.

### DESCRIPTION OF REFERENCE NUMERALS

1, 1X Tracking device
2 Storage device
3 Display device
4 Input device
5 Camera
11 Processor
12 Memory
13 Interface
100 Tracking system

What is claimed is:

1. A tracking device comprising:
at least one memory configured to store instructions, and
at least one processor configured to execute the instructions to:
perform, upon obtaining a target image including a plurality of objects at a reference time, first inference for inferring a motion of a tracking target at the reference time on assumptions that the objects are respectively regarded as the tracking target tracked based on time-series images which are obtained before the reference time;
perform second inference for inferring a motion of the tracking target at the reference time based on the time-series images; and
identify an object representing the tracking target among the plurality of objects in the target image, based on inference results of the first inference for the assumptions and an inference result of the second inference.

2. The tracking device according to claim 1,
wherein the at least one processor is configured to execute the instructions to
identify an inference result most similar to the inference result of the second inference among the inference results for the assumptions, and
identify the object representing the tracking target based on an assumption related to the identified inference result among the assumptions.

3. The tracking device according to claim 1,
wherein the at least one processor is configured to execute the instructions to
determine whether or not the tracking target is distinguishable among the plurality of objects, and
perform the first inference upon determining that the tracking target is distinguishable.

4. The tracking device according to claim 3,
wherein the at least one processor is configured to execute the instructions to
detect regions of the plurality of objects from the target image, and
determine, based on a degree of overlap of the regions, whether or not the tracking target is distinguishable.

5. The tracking device according to claim 1,
wherein the at least one processor is configured to execute the instructions to
generate a sequence of images showing the tracking target based on the time-series images and the target image for each of the assumptions, and
infer a motion at the reference time based on the sequence of images and a machine learning model, and
wherein the machine learning model is a model subjected to machine learning to output an inference result of a motion of an object upon taking, as an input, time-series images showing the object.

6. The tracking device according to claim 1,
wherein the at least one processor is configured to execute the instructions to infer a motion at the reference time by extrapolation, based on motion information representing a motion of the tracking target before the reference time, the motion information being generated based on the time-series images.

7. The tracking device according to claim 1,
wherein the at least one processor is configured to execute the instructions to generate a sequence of images showing the tracking target based on the time-series images, and infers a motion at the reference time based on the sequence of images and a machine learning model, and
the machine learning model is a model subjected to machine learning to output an inference result of a predicted motion of an object upon taking, as an input, time-series images showing the object.

8. The tracking device according to claim 1,
wherein the at least one processor is configured to execute the instructions to cause a display device to display the object identified as the tracking target on the target image in association with information representing a motion of the object, based on at least either of the inference results for the assumptions and the inference result of the second inference.

9. A data analysis method executed by a computer, comprising:
performing, upon obtaining a target image including a plurality of objects at a reference time, first inference for inferring a motion of a tracking target at the reference time on assumptions that the objects are respectively regarded as the tracking target tracked based on time-series images which are obtained before the reference time;
performing second inference for inferring a motion of the tracking target at the reference time based on the time-series images; and
identifying an object representing the tracking target among the plurality of objects in the target image, based on inference results of the first inference for the assumptions and an inference result of the second inference.

10. A non-transitory computer readable storage medium storing a program executed by a computer, the program causing the computer to:
perform, upon obtaining a target image including a plurality of objects at a reference time, first inference for inferring a motion of a tracking target at the reference time on assumptions that the objects are respectively regarded as the tracking target tracked based on time-series images which are obtained before the reference time;
perform second inference for inferring a motion of the tracking target at the reference time based on the time-series images; and
identify an object representing the tracking target among the plurality of objects in the target image, based on inference results of the first inference for the assumptions and an inference result of the second inference.
